(19) United States
(12) Patent Application Publication
(10) Pub. No.: US 2013/0051234 A1
(43) Pub. Date: Feb. 28, 2013

(54) METHOD AND APPARATUS FOR CONTROLLING TRANSMISSION RATE

(71) Applicant: Naoki MATSUOKA, Kawasaki (JP)

(72) Inventor: Naoki MATSUOKA, Kawasaki (JP)

(73) Assignee: FUJITSU LIMITED, Kawasaki-shi (JP)

(21) Appl. No.: 13/594,915

(22) Filed: Aug. 27, 2012

(30) Foreign Application Priority Data
Aug. 29, 2011 (JP) 2011-185576

(51) Int. Cl. H04L 12/24; H04L 12/26

(52) U.S. Cl. 370/235

(57) ABSTRACT

A disclosed method executed by a first physical computer includes: measuring a transmission rate of data to be transmitted to a second physical computer, for a group to which virtual machines executed on the first physical computer belong; transmitting a request packet including the measured transmission rate to the second physical computer; receiving, from the second physical computer, a response packet including a ratio for the group and first data used in determining whether congestion has occurred; and upon determining based on the first data, that the congestion has occurred, lowering an output rate of data that the virtual machines belonging to the group output to the second physical server so as to be equal to or greater than a lower limit value determined by a product of the ratio for the group and a transmission rate that is preset for the group.

### CROSS-REFERENCE TO RELATED APPLICATIONS

This application is based upon and claims the benefit of priority of the prior Japanese Patent Application No. 2011-185576, filed on Aug. 29, 2011, the entire contents of which are incorporated herein by reference.

### FIELD

This technique relates to a technique for controlling a transmission rate.

### BACKGROUND

The Infrastructure as a Service (IaaS) service in the cloud computing service is gaining attention as a new form of using an Information and Communication Technology (ICT) system. In the IaaS service, computing resources on a network are used to build virtual servers (hereafter, denoted as virtual machines or VMs), and the virtual machines are provided as a service for users.

On the cloud computing infrastructure that provides the IaaS service, virtual machines of plural companies, departments, sections (hereinafter, these are denoted to be tenants) operate, and virtual network environments are built, which are separated for each of the tenants by using logical partitioning technique such as Virtual LAN (Local Area Network) (VLAN) for the purpose of protecting security among the tenants.

From the aspect of security, by forming the virtual network, it becomes possible to avoid problems such as the leaking of information when packets intended for a certain tenant is delivered to a different tenant. However, problems may occur when attention is paid to the aspect of network resources (in other words, bandwidth). In other words, in an environment in which there is plural tenants that share a physical network, when one tenant is transmitting a large quantity of data, a problem occurs in that other tenants are affected by this large data transmission, and it may become nearly impossible for other tenants to perform the communication. This problem is caused because network resources are not secured for each tenant, which means that there is a state of competing for network resources.

In order to secure network resources in units of tenants, there is a method of providing plural queues for each output port in a physical network switch, and assigning an independent queue for each tenant. More specifically, the packet reading rate from each queue is controlled so that it never drops below a fixed rate (i.e. bandwidth secured for each tenant, in other words the minimum guaranteed rate). Furthermore, when there are no packets residing at another queue, control is performed so that transmission is performed at a rate equal to or greater than the minimum guaranteed rate. With such a control, even when a certain tenant is transmitting a large quantity of data, the transmission rate from each queue can always be maintained at the minimum guaranteed rate. Therefore, regardless of the state of each of the tenants, it is at least possible to perform data transmission at the minimum guaranteed rate.

However, as for many current physical network switches, due to hardware constraints, the number of queues per output port is limited to a small number such as 4 to 10, so it is difficult to provide queues for all tenants in a large-scale data center. Some products are physical network switches that have several tens of thousands of queues, however, the cost of such devices is extremely expensive, so in building a network using such switches, there is a problem in that the cost of the infrastructure increases.

Moreover, there is also a technique that performs control by the end host without performing control by the physical network switch. In this technique, as illustrated in FIG. 1, when performing communication using RTP (Real Time Packets) between the end hosts, control packets, such as RTCP (Real Time Control Packets), are transferred periodically between the end hosts, and the delay, throughput, number of discarded packets between the end hosts are measured, and the transmission rate is increased or decreased based on the measurement results. However, only control of the bandwidth between the end hosts is possible, and so this method cannot handle the case in which plural tenants execute one or plural virtual machines on one or plural physical machines and the communication is carried out between the virtual machines of one tenant.

This problem will be explained using a more detailed example. As illustrated in FIG. 2, virtual machines A1, A2 and A3 are included in tenant A, virtual machines B1 and B2 are included in tenant B, virtual machines C1 and C2 are included in tenant C, and each virtual machine is presumed to be provided on different physical machines. Moreover, in each link (for example a link rate of 1 Gbps) on a physical network, it is assumed that capacity design has been performed in order that a bandwidth of 200 Mbps for tenant A, and a bandwidth of 400 Mbps for tenants B and C can be secured as minimum guaranteed rates.

In the state illustrated in FIG. 2, it is assumed that virtual machine A1 that belongs to tenant A transmits data to virtual machine A3 at 600 Mbps, and virtual machine A2 transmits data to virtual machine A3 at 400 Mbps.

Even in such a state, a total of 1 Gbps of traffic is flowing in the link between switch A and switch B. In this case, the transmission rate of the traffic is equal to or less than the link rate, so the network is in a non-congested state.

Here, as illustrated in FIG. 3, it is assumed that virtual machine B1 that belongs to tenant B begins to transmit data to virtual machine B2 at 400 Mbps, and virtual machine C1 that belongs to tenant C begins to transmit data to virtual machine C2 at 400 Mbps.

Then, a total of 1.8 Gbps of traffic is flowing into the link between switch A and switch B. Therefore, for example, by exchanging the control packets, it is possible to detect the increase of the delay time, increase of the number of discarded packets and decrease of the throughput, and it is also possible to detect the occurrent of the congestion.

When such a congested state is detected, the congestion is eliminated by lowering the data transmission rate, however, at the same time, it is requested that the minimum guaranteed rate of each tenant be secured. The data transmission rate from virtual machine B1 to virtual machine B2 is the minimum guaranteed rate of tenant B of 400 Mbps, so lowering the transmission rate is difficult. Similarly, the data transmission rate from virtual machine C1 to virtual machine C2 is the minimum guaranteed rate of tenant C of 400 Mbps, so lowering the transmission rate is difficult.

On the other hand, the data transmission rate from virtual machine A1 to virtual machine A3 is greater than the minimum transmission rate of tenant A, and the data transmission rate from virtual machine A2 to virtual machine A3 is also greater than the minimum transmission rate of tenant A, so it is possible to lower the data transmission rate. However, as illustrated in FIG. 4, the data transmission rate from virtual machine A1 to virtual machine A3 cannot be less than the minimum guaranteed rate of 200 Mbps. Similarly, the data transmission rate from virtual machine A2 to virtual machine A3 cannot be less than the minimum guaranteed rate of 200 Mbps. Therefore, the total traffic flow in the link between switch A and switch B is 1.2 Gbps, so it is not possible to eliminate congestion. As a result, packets for tenant B and tenant C are discarded, and it is not possible to secure the minimum guaranteed rate for tenant B and tenant C.

This occurs because this conventional technique is a technique for avoiding congestion not for securing the minimum guaranteed rate, and this technique does not have a way of collectively controlling the transmission rates between two or more sets of computers.

Namely, there is no conventional method for controlling the output rate so as not to be less than the minimum guaranteed rate for each group of the virtual machines.

### SUMMARY

A control method according to a first aspect of this technique includes: (a) measuring a transmission rate of data to be transmitted to a second physical computer, for a group to which one or plural virtual machines executed on a first physical computer belong; (b) transmitting a request packet including the measured transmission rate to the second physical computer; (c) receiving, from the second physical computer, a response packet including a ratio for the group and first data used in determining whether congestion has occurred; and (d) upon determining based on the first data, that the congestion has occurred, lowering an output rate of data that the one or plural virtual machines belonging to the group output to the second physical server to a second output rate that is equal to or greater than a lower limit value determined by a product of the ratio for the group and a transmission rate that is preset for the group, wherein the second output rate is less than a present output rate.

A control method according to a second aspect of this technique includes: (a) receiving, from a second physical computer, a request packet including a transmission rate measured for a group to which a virtual machine executed on the second physical computer belongs; (b) generating, for the group, data used in determining whether or not congestion has occurred between the first physical computer and the second physical computer, from the request packet; (c) calculating a ratio for the group, by calculating a rate of the transmission rate with respect to a sum of a total sum of second transmission rates for the group, which are included in request packets received from other physical computers, and the transmission rate; (d) generating a response packet including the ratio for the group and the generated data; and transmitting the response packet to the second physical computer.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a diagram to explain a conventional art;

FIG. 2 is a diagram to explain a problem in the conventional art;

FIG. 3 is a diagram to explain a problem in the conventional art;

FIG. 4 is a diagram to explain a problem in the conventional art;

FIG. 5 is a system outline diagram of a first embodiment;

FIG. 6 is a functional block diagram representing a configuration of a physical machine, which relates to transmission;

FIG. 7 is a functional block diagram representing a configuration of the physical machine, which relates to reception;

FIG. 8 is a diagram representing a processing flow in the first embodiment;

FIG. 9 is a system outline diagram relating to a second embodiment;

FIG. 10 is a diagram to explain communication states relating to the second embodiment;

FIG. 11 is a diagram depicting a configuration of a physical server (transmitting side);

FIG. 12 is a diagram depicting an example of data held by a distribution unit;

FIG. 13 is a diagram depicting an example of a packet format of a request packet;

FIG. 14 is a diagram depicting an example of a packet format of a response packet;

FIG. 15 is a diagram depicting an example of data stored in a data storage unit of a controller at the transmitting side;

FIG. 16 is a diagram depicting a configuration of a physical server (receiving side);

FIG. 17 is a diagram depicting an example of data stored in a data storage unit of a controller at the receiving side;

FIG. 18 is a diagram depicting a processing flow in the second embodiment;

FIG. 19 is a diagram to explain communication states relating to the second embodiment;

FIG. 20 is a diagram depicting an example of time change of a reading rate;

FIG. 21 is a diagram depicting communication states relating to the second embodiment;

FIG. 22 is a diagram depicting an example of time change of the reading rate;

FIG. 23 is a diagram depicting an example of time change of the reading rate;

FIG. 24 is a diagram to explain a third embodiment;

FIG. 25 is a diagram to explain the third embodiment;

FIG. 26 is a diagram depicting a processing flow relating to the third embodiment; and

FIG. 27 is a functional block diagram of a computer.

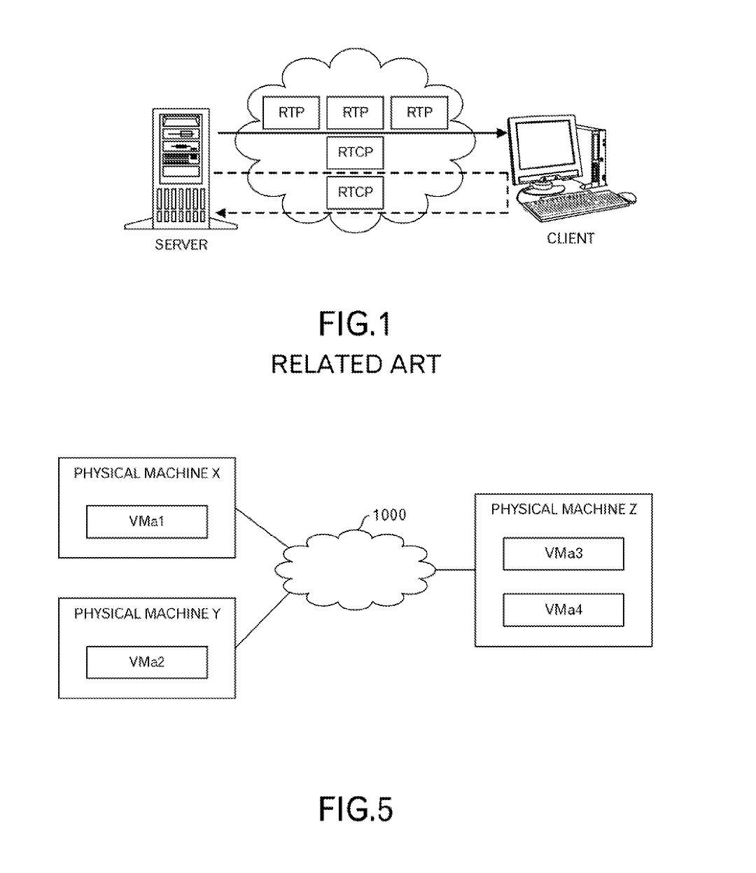

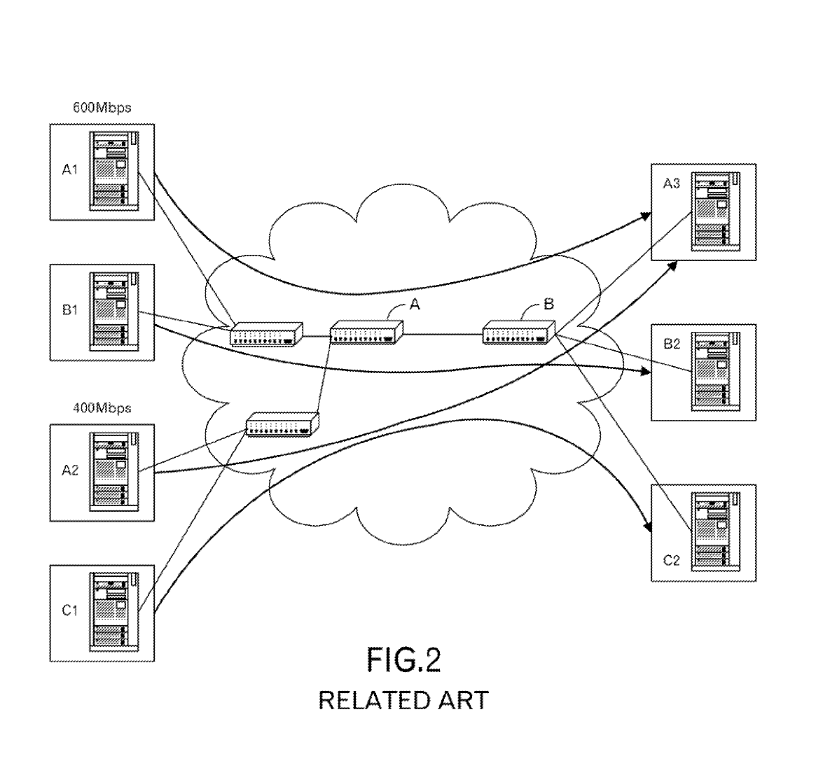

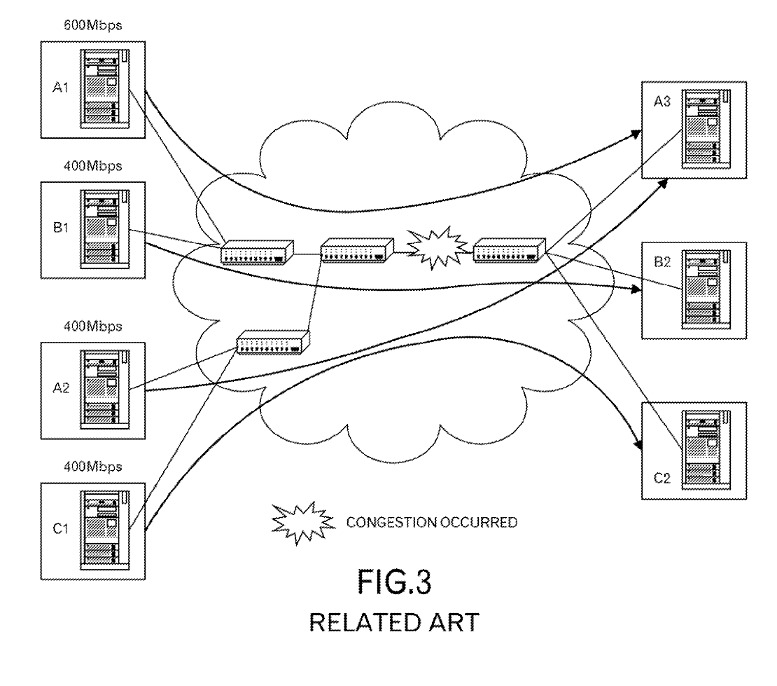

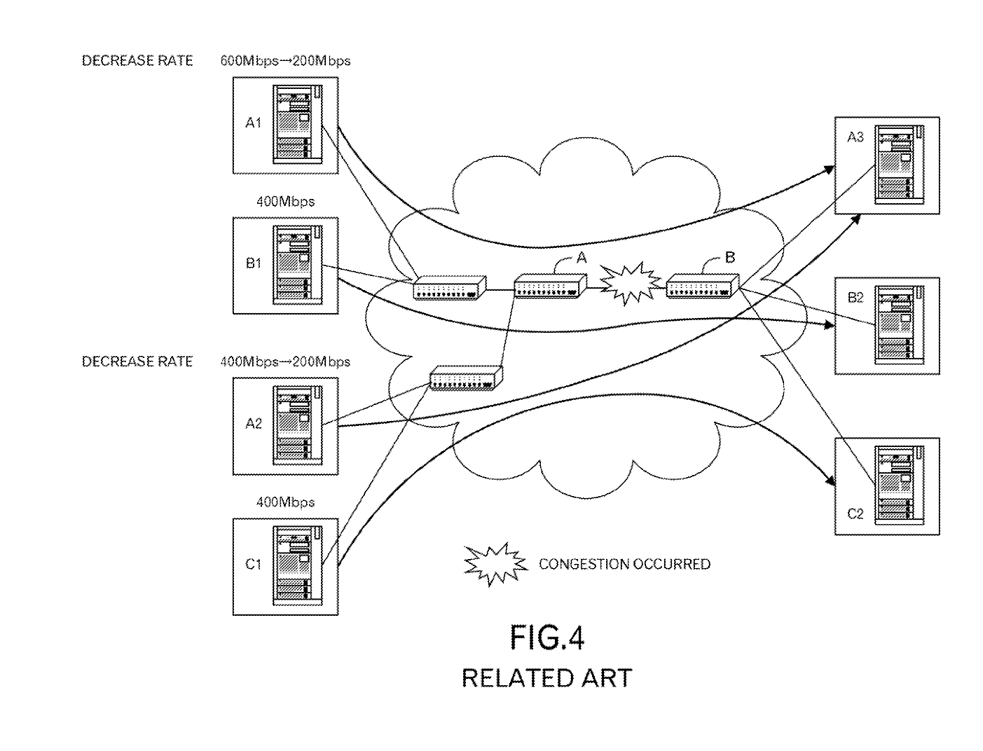

### DESCRIPTION OF EMBODIMENTS

### Embodiment 1

As illustrated in FIG. 5, in a first embodiment of this technique, it is assumed that physical machine X, physical machine Y and physical machine Z are connected to a network 1000. Then, it is also assumed that in the physical machine X, a virtual machine VMa1 for group A is executed, in the physical machine Y, a virtual machine VMa2 for the group A is executed, and in the physical machine Z, virtual machines VMa3 and VMa4 for the group A are executed. It is also assumed that data transmission is being carried out from the virtual machine VMa1 to the virtual machine VMa3, and data transmission is being carried out from the virtual machine VMa2 to the virtual machine VMa4.

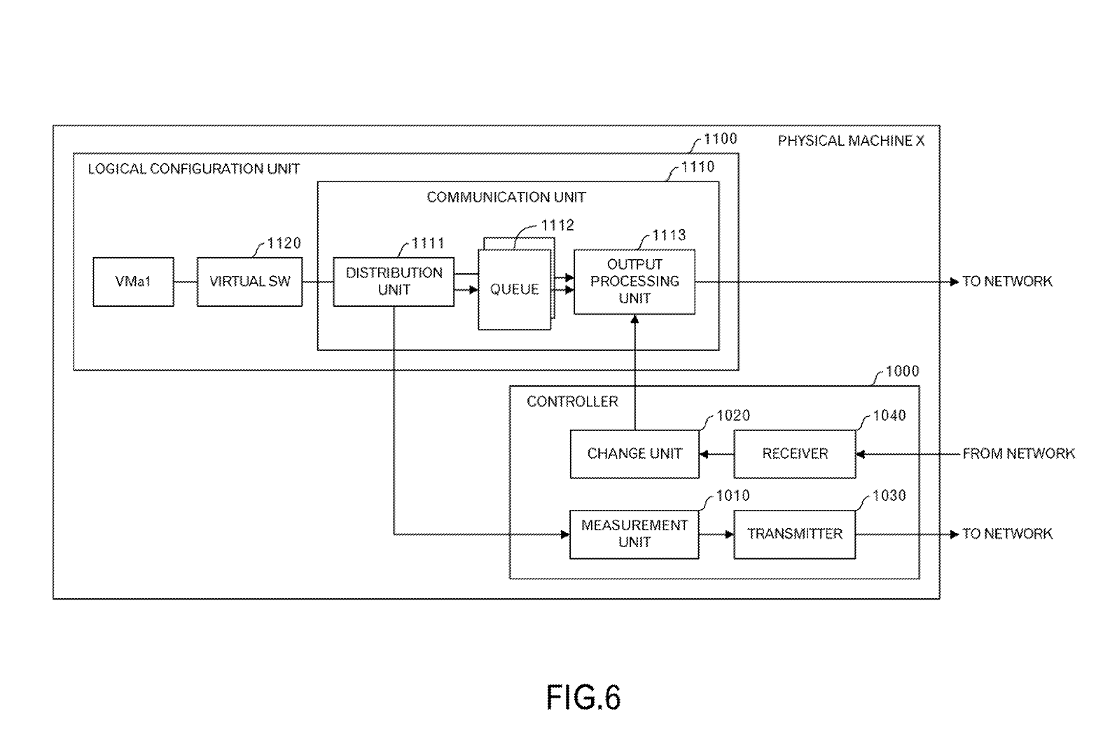

The configuration relating to data transmission in the physical machines X and Y in this embodiment is explained using the physical machine X. As illustrated in FIG. 6, the physical machine X has a logical configuration unit 1100 for the group A and a controller 1000. Here, only the virtual machine VMa1 of the group A is being executed, so only the logical configuration unit 1100 for the group A is illustrated, however, when a virtual machine for another group is executed, a logical configuration unit for that group is provided.

The controller 1000 has a measurement unit 1010, a change unit 1020, a transmitter 1030 and a receiver 1040. The measurement unit 1010 measures the transmission rate for each of the other physical machines on which the virtual machines of the group A are executed. When there are plural groups, the measurement unit 1010 carries out measurement for each group. The transmitter 1030 generates a request packet, which is a control packet, from data received from the measurement unit 1010, and transmits that request packet to the other physical machines. The receiver 1040 receives a response packet (a kind of control packet) for the request packet, and outputs the data of the response packet to the change unit 1020. The change unit 1020 carries out a process for changing the transmission rate from the physical machine X to each of the other physical machines according to the data that is included in the response packets. When there are plural groups, the change unit 1020 also carries out a processing for each group.

The logical configuration unit 1100 for the group A includes a virtual machine VMa1, a virtual switch SW 1120 that is logically connected to the virtual machine VMa1, and a communication unit 1110 that is logically connected to the virtual switch SW1120. The number of virtual switches SW is also not limited to “1”.

The communication unit 1110 has a queue 1112 for each of other physical machines on which the virtual machines of the group A are executed, a distribution unit 1111, and an output processing unit 1113 that read packets from the queue 1112 and transmits the packets to other physical machines. The distribution unit 1111 identifies the queue for the destination physical machine from the destination address of the packet received from the virtual switch SW 1120, and inputs the packet in that queue. Moreover, the distribution unit 1111, for example, notifies the measurement unit 1010 of the data amount of the received packet that was input in the queue 1112, for each destination physical machine. The measurement unit 1010 uses the data amount that was notified from the distribution unit 1111 to calculate the transmission rate per unit time for each physical machine, for each group. The output processing unit 1113 reads packets from each queue 1112, and outputs the read packets to the physical communication unit of the physical machine X. The output processing unit 1113 also changes the reading rate from each queue (also called “output rate”) according to an instruction from the change unit 1020.

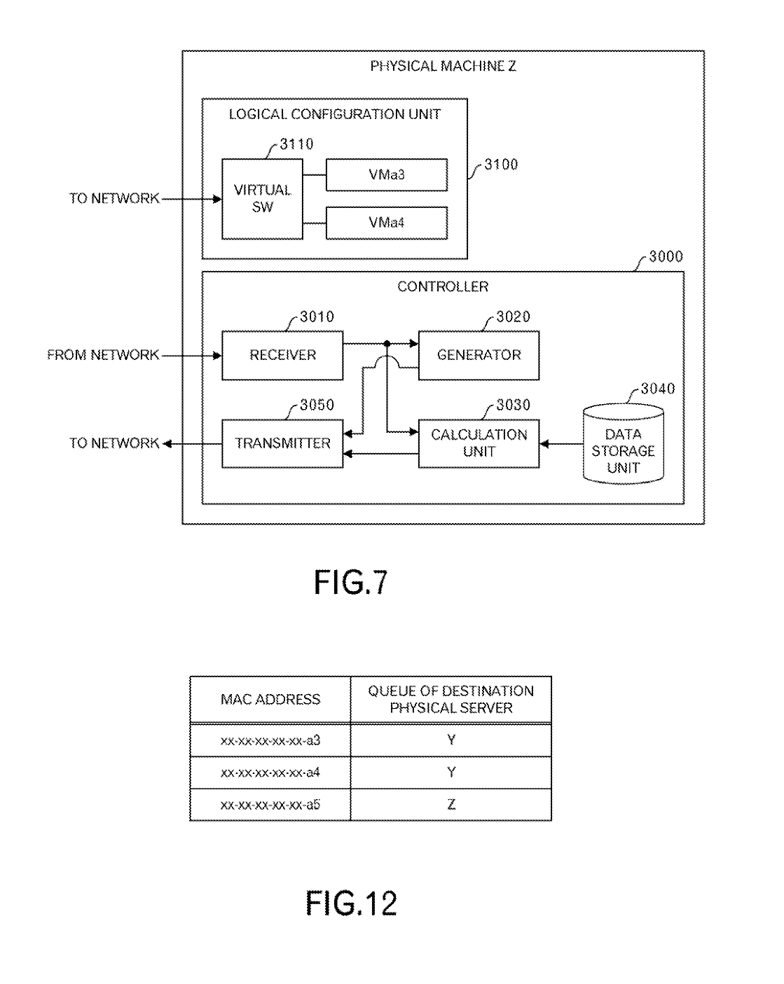

FIG. 7 illustrates a configuration relating to data reception in the physical machine Z. The physical machine Z has a logical configuration unit 3100 for the group A, and a controller 3000. The controller 3000 has a receiver 3010, a generator 3020, a calculation unit 3030, a data storage unit 3040 and a transmitter 3050. The receiver 3010 receives a request packet from other physical machines, and outputs the data of that request packet to the generator 3020 and the calculation unit 3030. The generator 3020 generates data that is used to determine whether or not the congestion occurs, from the data of the request packet, and outputs the generated data to the transmitter 3050. The data storage unit 3040 stores the data of the request packets that are received from other physical machines. The calculation unit 3030 uses the data of the currently received request packet and the data that is stored in the data storage unit 3040, and calculates a ratio for the physical machine that is the transmission source of the request packet that was received this time, using a method that will be described later, and outputs the calculated ratio to the transmitter 3050. The transmitter 3050 uses the data that was received from the generator 3020 and the calculation unit 3030 to generate a response packet, and transmits the generated response packet to the physical machine that is the transmission source of the request packet that was received this time.

The logical configuration unit 3100 for the group A has a virtual switch SW 3110 and virtual machines VMa3 and VMa4 that are connected to the virtual switch SW 3110. In the logical configuration unit 3100 on the receiving side, as normal, the virtual switch SW 3110 that received a packet from the physical communication unit of the physical machine Z outputs the packet to the destination virtual machine VMa3 or VMa4.

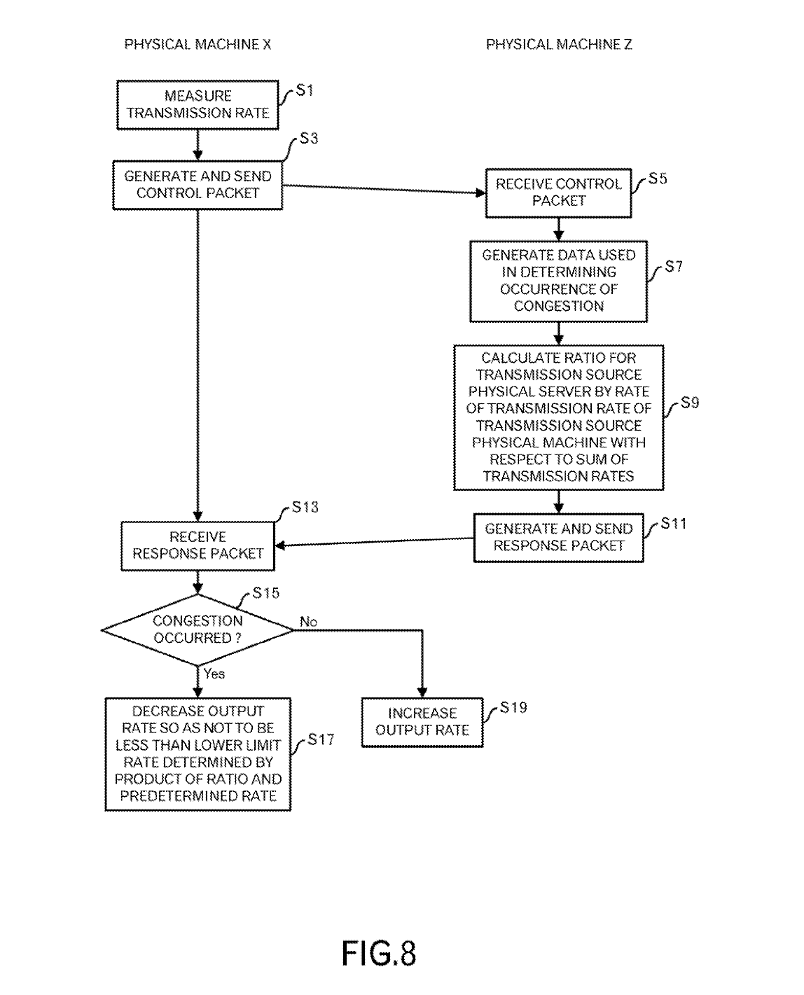

Next, the processing flow in this embodiment will be explained using FIG. 8. The measurement unit 1010 of the controller 1000 in the physical machine X measures the transmission rate, together with the distribution unit 1111 (FIG. 8: step S1). As described above, the transmission rate is measured for each destination physical machine for each group, however, here it will be assumed that virtual machines of only the group A are currently executed, and that the physical machine X and physical machine Y are not carrying out communication. Accordingly, attention will be paid only to the group A and the physical machine Z.

The transmitter 1030 then generates a request packet that includes the transmission rate for the group A and physical machine Z, which was measured by the measurement unit 1010, and transmits the generated request packet to the physical machine Z (step S3). The request packet also has a role in determining whether or not there is congestion in the path from the physical machine X to the physical machine Z. Transmission of request packets is carried out at a predetermined period of 100 msec, for example. However, the transmission does not have to be carried out periodically.

The receiver 3010 of the controller 3000 in the physical machine Z receives the request packet from the physical machine X (step S5), and outputs the data of the received request packet to the generator 3020 and calculation unit 3030. The generator 3020 generates data that will be used in determining whether or not the congestion occurs, from the data of the request packet, and outputs the generated data to the transmitter 3050 (step S7). The data that is used in determining whether or not the congestion occurs may be the one-way delay time identified from the request packet that was received this time, or may be a flag that represents whether or not the congestion has occurred according to whether or not the one-way delay time is equal to or greater than a predetermined threshold value. The one-way delay time may be calculated by ((the time at which the current request packet is received)−(the transmission time that is included in the request packet)). Furthermore, after confirming that the congestion has not occurred, the estimated arrival time of the request packet may be calculated by adding time when a certain request packet was received and the transmission period of the request packet, and the one-way delay time may be calculated as the difference between the actual arrival time and that estimated arrival time. It is also possible to detect the occurrence of the congestion based on other measurement results such as the throughput or ratio of the discarded packets.

Moreover, the calculation unit 3030 calculates the ratio for the group A and the transmission source physical machine X, from the rate of the transmission rate for physical machine X, which is the transmission source, with respect to the sum of the transmission rate for the physical machine X, on which a virtual machine for the group A is executed, and the transmission rate for the physical machine Y on which a virtual machine for the group A is executed, similarly (step S9). As for the transmission rate for the physical machine X, data that is included in the currently received request packet is used. This data is stored in the data storage unit 3040. In addition, as for the transmission rate for the physical machine Y, the most recent data that is stored in the data storage unit 3040 is used. The calculation unit 3030 outputs data of the calculated ratio to the transmitter 3050.

For example, when the transmission rate for the physical machine X is 400 Mbps, and the transmission rate for the physical machine Y is 600 Mbps, the ratio for the physical machine X is calculated as 400/(400+600)=0.4. In some cases, it is also possible to use a value, which is the result of adding an adjustment to the rate of the transmission rate with respect to the sum, as the calculated ratio. For example, when the physical machine X is set to have a priority, a predetermined value may be added to the rate of the transmission rate for the physical machine X when calculating the ratio for the physical machine X. In this case, it is also possible instead to subtract a predetermined value from the rate of the transmission rate for the physical machine Y when calculating the ratio for the physical machine Y.

The transmitter 3050 then generates a response packet that includes data that will be used in determining the occurrence of the congestion and data of the ratio, and transmits the generated response packet to the physical machine X (step S11).

On the other hand, the receiver 1040 of the controller 1000 in the physical machine X receives the response packet (step S13), and outputs the data of the response packet to the change unit 1020. The change unit 1020 determines, from the data that is used in determining whether or not the congestion has occurred, whether the congestion has occurred (step S15). When the data used in determining whether or not the congestion has occurred is the one-way delay time, the change unit 1020 compares the one-way delay time with a predetermined threshold value, and when the one-way delay time is equal to or greater than the threshold value, the change unit 1020 determines that the congestion has occurred. However, when the data used in determining whether or not the congestion has occurred is a flag that represents whether or not the congestion has occurred, the change unit 1020 determines whether the value of that flag represents that the congestion has occurred.

When the congestion has not occurred, the output processing unit 1113 can output the packets to the physical machine Z at a higher rate than the rate at which packets are being read from the current queue 1112. Therefore, the change unit 1020 outputs an instruction to the output processing unit 1113 to raise the current output rate of the packets to the physical machine Z (step S19). Any method may be used for raising the output rate, however, it is not possible to raise the rate higher than the upper limit rate of the physical communication unit of the physical machine X.

On the other hand, when the congestion has occurred, the change unit 1020 outputs an instruction to the output processing unit 1113 to lower the current output rate for the packets to the physical server Z so that the rate does not become less than the lower limit rate that is set from the product of the ratio that is included in the response packet and a predetermined rate (for example, the minimum guaranteed rate that is set for the group A, for example) (step S17).

For example, when the ratio is 0.4 and the predetermined rate is 500 Mbps, the lower limit rate is calculated as 200 Mbps.

Any method may be used for lowering the output rate, however, the output rate should not become less than the lower limit rate described above. As long as the output rate is equal to or greater than the lower limit rate, it is possible to secure the minimum guaranteed rate for the group A as the overall system. It is also possible to add an adjustment to the product of the ratio that is included in the response packet and the predetermined rate. For example, when the physical machine X is set so as to have a priority, the lower limit rate may be calculated by adding a predetermined value to the product of the ratio that is included in the response packet and the predetermined rate. In this case, the predetermined value is subtracted from the lower limit rate that was calculated in the physical machine Y.

By carrying out the processing as described above, it is possible to secure the minimum guaranteed rate for each group as an overall system even in a condition where the congestion has occurred. When the system is designed properly and the minimum guaranteed rates for the respective groups are added, the result should be equal to or less than the bandwidth for each link of the network. Therefore, by carrying out the processing such as described above, it is possible to resolve the congestion.

In order to make it easier to understand the explanation above, each physical machine is illustrated as having one of the configuration of the transmitting side and the configuration of the receiving side, however, actually, each physical machine has both of them.

### Embodiment 2

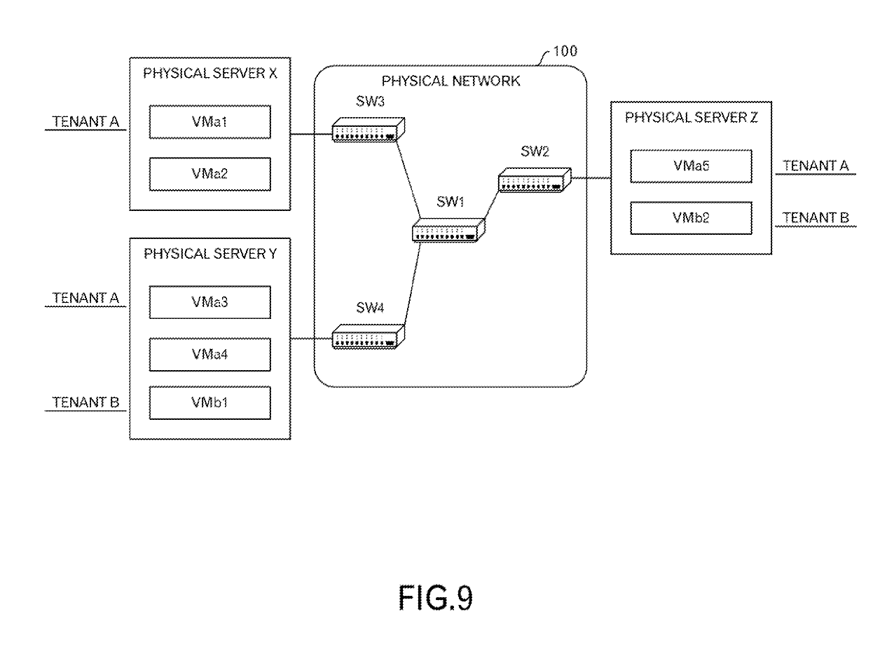

The system configuration example relating to a second embodiment of the technique will be explained using FIG. 9. Switches SW1 to SW4 are included in a physical network 100. The switch SW3 is connected to a physical server X, and is further connected to the switch SW1. The switch SW4 is connected to a physical server Y, and also connected to the switch SW1. The switch SW1 is connected to the switches SW3, SW4 and SW2. The switch SW2 is connected to the switch SW1 and is further connected to a physical server Z.

In this embodiment, virtual machines VMa1 and VMa2 of tenant A are executed in the physical server X, virtual machines VMa3 and VMa4 of tenant A, and virtual machine VMb1 of tenant B are executed in the physical server Y. Furthermore, virtual machine VMa5 of the tenant A and virtual machine VMb2 of the tenant B are executed in the physical server Z.

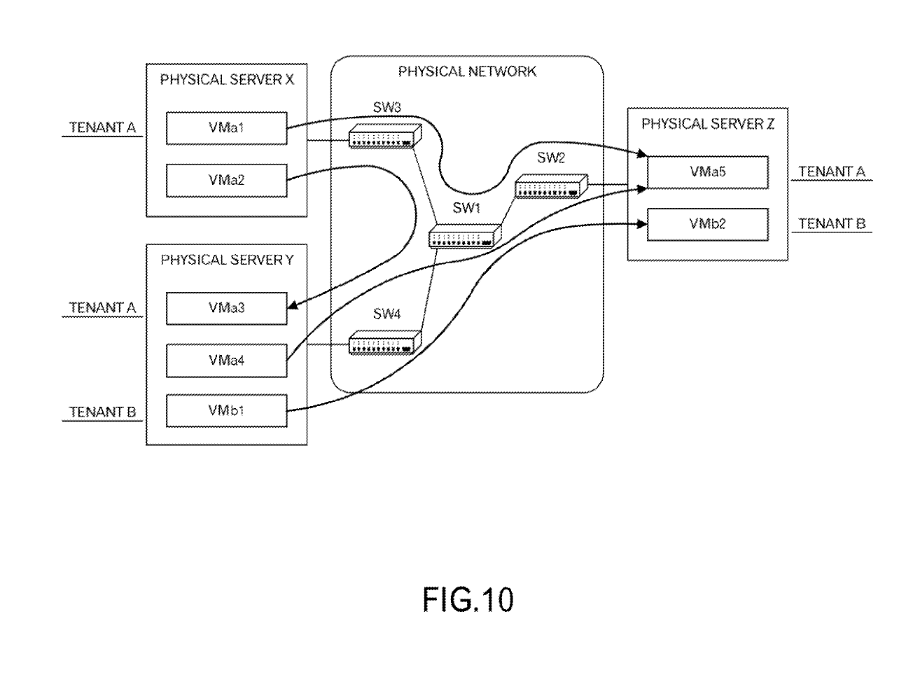

Communication is carried out among virtual machines that belong to the same tenant. However, in order to simplify the explanation, it is assumed that communication as illustrated in FIG. 10 is carried out. In other words, in the physical server X, data is transmitted from the virtual machine VMa1 to the virtual machine VMa5, and data is transmitted from the virtual machine VMa2 to the virtual machine VMa3. Moreover, in the physical server Y, data is transmitted from the virtual machine VMa4 to the virtual machine VMa5, and data is transmitted from the virtual machine VMb1 to the virtual machine VMb2.

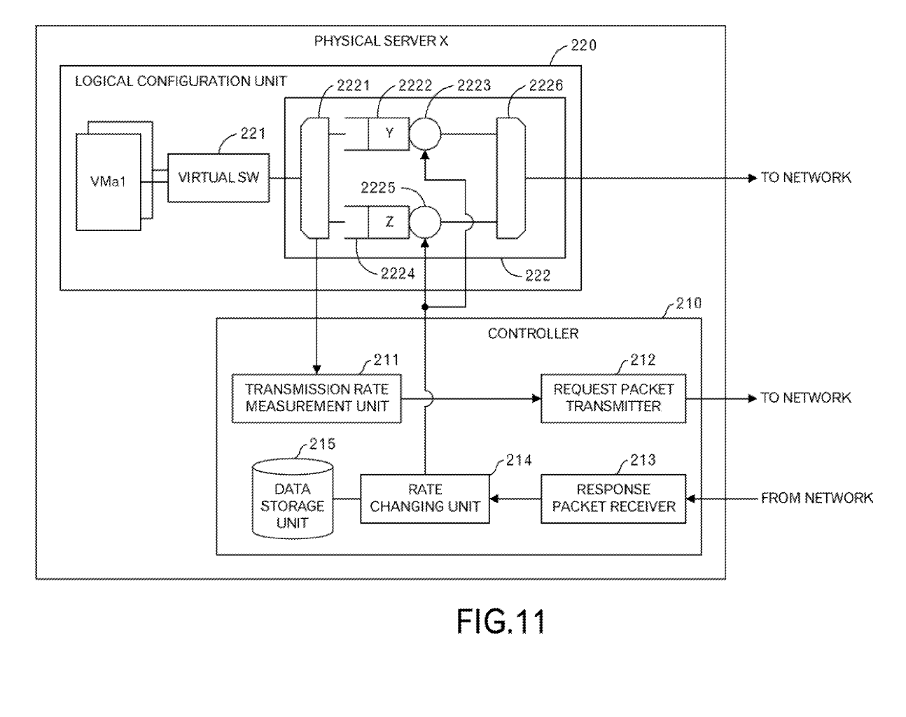

Next, the configuration of the physical server X (transmitting side) in this embodiment will be explained using FIG. 11. In the example in FIG. 10, the physical server X is a physical server on the data transmitting side, and has a logical configuration unit 220 for the tenant A and a controller 210. When virtual machines for tenants other than tenant A are being executed, a logical configuration unit 220 is also provided for that tenant as well.

The logical configuration unit 220 for the tenant A has the virtual machines VMa1 and VMa2, a virtual switch SW 221 that is logically connected to the virtual machines VMa1 and VMa2, and a communication unit 222 that is connected to the virtual switch SW 221.

Moreover, the controller 210 has a transmission rate measurement unit 211, a request packet transmitter 212, a response packet receiver 213, a rate changing unit 214 and a data storage unit 215.

The communication unit 222 has a distribution unit 2221, queues 2222 and 2224 for other physical servers on which the virtual machines of the tenant A are executed, reading units 2223 and 2225 that read from the queues 2222 and 2224, and a selector 2226.

The distribution unit 2221 receives packets that are outputted from the virtual machines VMa1 and VMa2 via the virtual switch SW 221, and outputs the packets to the queue 2222 or 2224 for the destination physical server that is identified from the destination address. For example, the distribution unit 2221 identifies the queue 2222 or 2224 of the output destination based on data such as illustrated in FIG. 12. In the example in FIG. 12, identifiers of the queues for the destination physical servers are registered in association with the MAC addresses of the virtual machines. The distribution unit 2221 measures the amount of data of packets that are input in the queue 2222 or 2224 for each destination physical server, and outputs the result to the transmission rate measurement unit 211.

The reading unit 2223 reads the packets from the queue 2222 at the reading rate instructed by the rate changing unit 214, and outputs the packets to the selector 2226. Moreover, the reading unit 2225 reads the packets from the queue 2224 at the reading rate instructed from the rate changing unit 214, and outputs the result to the selector 2226. The selector 2226 outputs the packets to the physical communication unit of the physical server X at appropriate timing.

The transmission rate measurement unit 211 of the controller 210 measures (or calculates) the transmission rate of each destination physical server for the tenant A, and outputs the results to the request packet transmitter 212. The request packet transmitter 212 generates a request packet using the transmission rates from the transmission rate measurement unit 211, and transmits the generated request packet to the destination physical server. When virtual machines are executed for plural tenants, the transmission rates for the same destination physical server may be included in the same request packet and the request packet may be transmitted to the same destination physical server.

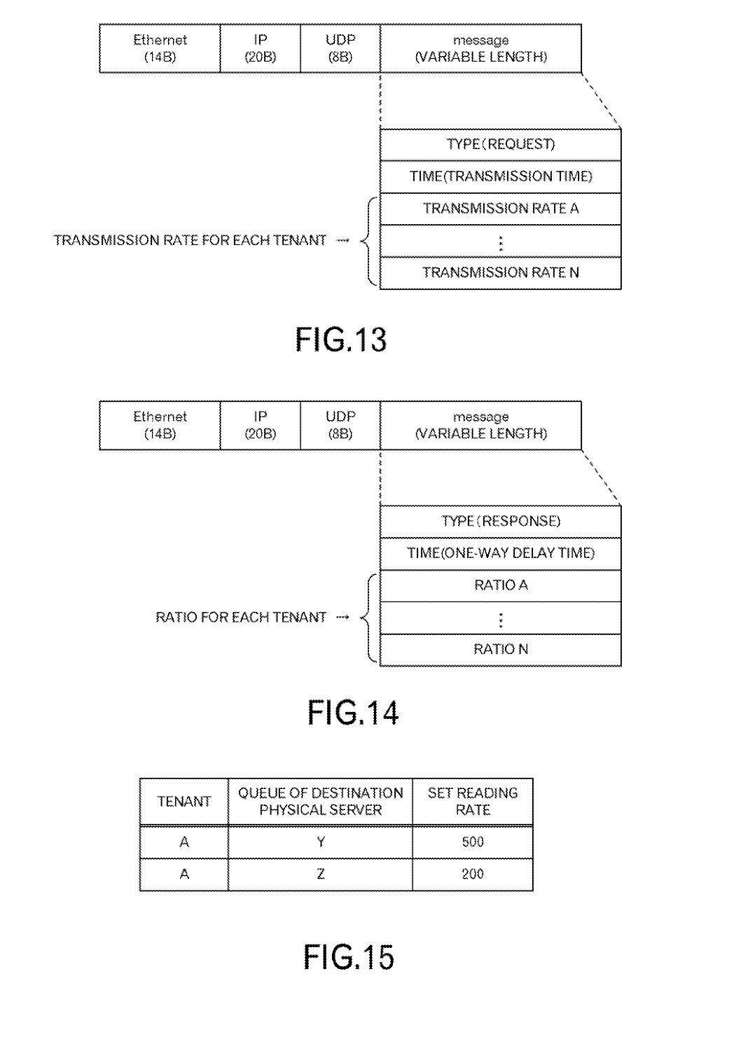

FIG. 13 illustrates an example of the packet format of the request packet that is a control packet. The request packet includes an Ethernet header (Ethernet is a registered trademark) (14 Bytes), an IP header (20 Bytes), a UDP header (8 Bytes) and the message body (variable length). The message body includes the control packet type (request), time (transmission time), and the transmission rate for each tenant. The transmission rate is set as a value in TLV (Type-Length-Value) format, for example.

In the example described above, in the case of a request packet addressed to the physical server Z, virtual machines are executed on the physical server X only for the tenant A. Therefore, the request packet only includes the transmission rate to the physical server Z for the tenant A. On the physical server Y, virtual machines for the tenants A and B are executed, so in the case of a request packet addressed to the physical server Z, the request packet includes the transmission rate to the physical server Z for the tenant A, and the transmission rate to the physical server Z for the tenant B.

Moreover, the response packet receiver 213 of the controller 210 receives a response packet, which is a control packet, from another physical server, and outputs the data of that response packet to the rate changing unit 214. FIG. 14 illustrates an example of the packet format of a response packet, which is the control packet. The response packet includes an Ethernet header (Ethernet is a registered trademark) (14 Bytes), an IP header (20 Bytes), a UDP header (8 Bytes) and the message body (variable length). The message body includes the control packet type (response), the time (one-way delay time), and ratio for each tenant. The ratio is set as a value in TLV (Type-Length-Value) format, for example. The ratio will be explained in detail later.

The rate changing unit 214 determines whether or not the congestion has occurred, by determining whether or not the one-way delay time is equal to or greater than a predetermined threshold value. When the congestion has occurred, the rate changing unit 214 controls the reading unit 2223 or 2225 so that the reading rate for reading the packets from the queue 2222 or 2224 for the transmission source physical server of the response packet is not less than the lower limit rate that is set according to the ratio for each tenant. The reading rate that is instructed for the reading unit 2223 or 2225 is stored in the data storage unit 215. The data storage unit 215 stores data such as illustrated in FIG. 15, for example. In the example in FIG. 15, the identifier of the tenant, the identifier of the queue for the destination physical server, and the set reading rate are associated.

The physical server Y has a logical configuration unit for the tenant A, a logical configuration unit for the tenant B and a controller 210.

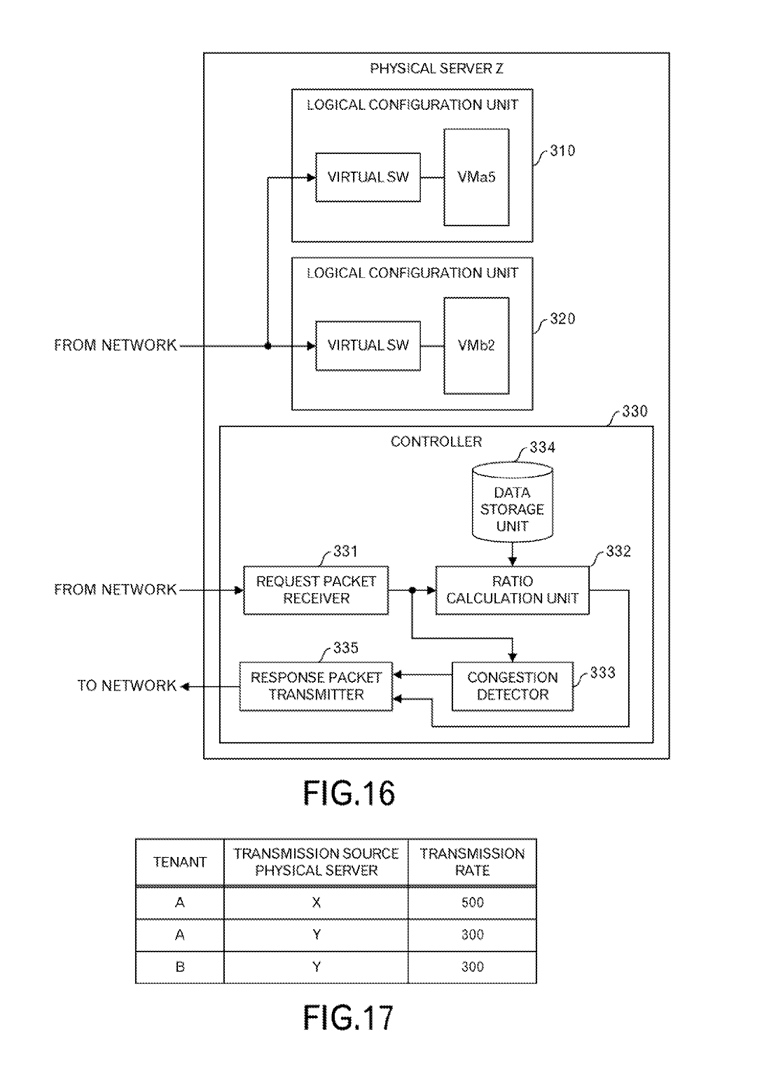

Next, the configuration of the physical server Z (receiving side) in this embodiment will be explained using FIG. 16. In the example in FIG. 16, the physical server Z has a logical configuration unit 310 for the tenant A, a logical configuration unit 320 for the tenant B and a controller 330. The logical configuration unit 310 for the tenant A and the logical configuration unit 320 for the tenant B are such that the virtual machine VMa5 or VMb2 is connected to a virtual switch SW, and are the same as the conventional case, so will not be explained more than this.

On the other hand, the controller 330 has a request packet receiver 331, ratio calculation unit 332, congestion detector 333, data storage unit 334, and response packet transmitter 335. The request packet receiver 331 receives request packets from other physical servers, and outputs the received data to the ratio calculation unit 332 and congestion detector 333.

The congestion detector 333 calculates the one-way delay time using the transmission time that is included in the request packet, and outputs the result to the response packet transmitter 335. The ratio calculation unit 332 uses the transmission rate of the transmission source physical server that is included in the request packet, and the transmission rates of the other physical servers that are stored in the data storage unit 334, to calculate, for each tenant, the ratio of the transmission rate of the transmission source physical machine with respect to the sum of the transmission rates at which the virtual machines belonging to the same tenant transmit data to its own physical server. For example, the data storage unit 334 stores data such as illustrated in FIG. 17. In the example in FIG. 17, identifiers for the tenants, identifiers for the transmission source physical servers, and the transmission rates are associated and stored. For example, when data of the transmission rate (300 Mbps) for the tenant A is included in the request packet from the physical server X, the transmission rates for tenant A and physical server other than the physical server X are read from the data storage unit 334. In this case, the transmission rate (300 Mbps) for the physical server Y is read. The transmission rate that is included in the currently received request packet is stored in the data storage unit 334 as the transmission rate for the tenant A and the transmission source physical server X. Then, the ratio calculation unit 332 obtains the ratio 300/(300+300)=0.5.

The response packet transmitter 335 generates a response packet that includes the ratio that was calculated by the ratio calculation unit 332 and the one-way delay time that was calculated by the congestion detector 333, and transmits the generated response packet to the physical server X that is the transmission source of the request packet.

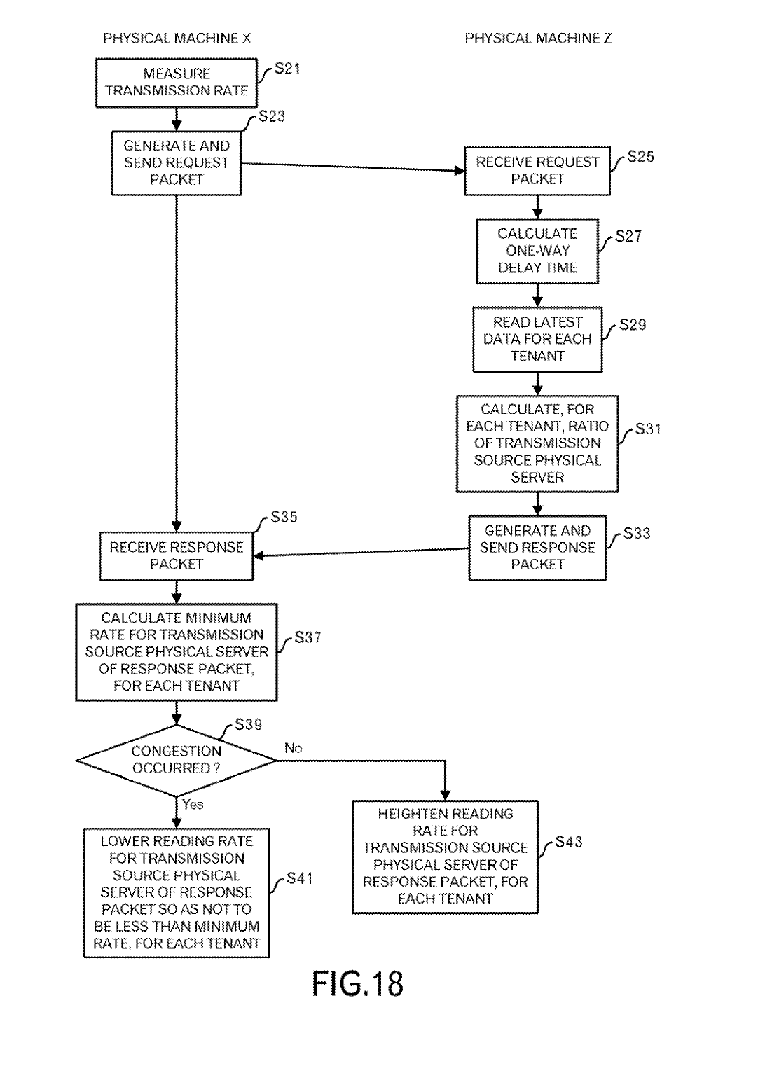

Next, the contents of the processing by the system described above will be explained using FIG. 18. The transmission rate measurement unit 211 of the controller 210 in the physical server X cooperates with the distribution unit 2221 to measure the transmission rate with respect to each destination physical server for each tenant (FIG. 18: step S21). For example, when a request packet is transmitted periodically, the transmission rate measurement unit 211 calculates the amount of data that is transmitted per unit time (for example, 1 second) for each transmission interval of the request packet, or in other words, the transmission rate. Then, at the transmission timing for transmitting the request packet to the physical server Z, the transmission rate measurement unit 211 outputs the most recent transmission rate to the request packet transmitter 212, and the request packet transmitter 212 generates a request packet that includes the transmission time and the transmission rate to the physical server Z for each tenant, and transmits the generated request packet to the physical server Z (step S23).

The request packet receiver 331 of the controller 330 in the physical server Z receives the request packet from the physical server X (step S25), and outputs the data of that request packet to the ratio calculation unit 332 and congestion detector 333. The congestion detector 333 calculates the one-way delay time from the difference between the time the request packet was received and the transmission time that is included in the request packet, and outputs the result to the response packet transmitter 335 (step S27). Moreover, the ratio calculation unit 332 reads from the data storage unit 334, the most recent transmission rates for the physical servers other than the transmission source physical server for each tenant for which the transmission rate is included in the request packet (step S29). When the transmission rate only for the tenant A is included in the request packet, the ratio calculation unit 332 reads from the data storage unit 334, the most recent transmission rate for the physical server Y that is other than the transmission source physical server X.

Then, the ratio calculation unit 332 calculates, for each tenant, the ratio of the physical server that is the transmission source of the request packet, and outputs the result to the response packet transmitter 335 (step S31). More specifically, the ratio calculation unit 332 calculates, for each tenant, the ratio of the transmission rate that is included in the request packet with respect to the sum of the transmission rates that are read from the data storage unit 334 and the transmission rate that is included in the request packet.

The response packet transmitter 335 generates a response packet that includes the one-way delay time and the calculated ratio for each tenant, and transmits the generated response packet to the physical server X (step S33). The response packet receiver 213 of the controller 210 in the physical server X receives the response packet from the physical server Z (step S35), and outputs the data of that response packet to the rate changing unit 214. When the rate changing unit 214 receives the data of the response packet, the rate changing unit 214 calculates, for each tenant, the minimum rate for the physical server that is the transmission source of the response packet (step S37). More specifically, the rate changing unit 214 calculates the minimum rate for each tenant by multiplying the minimum guaranteed rate that was set beforehand for the tenant by the ratio that is included in the response packet. The minimum guaranteed rate for each tenant may be stored in the data storage unit 215.

Furthermore, the rate changing unit 214 determines whether or not the congestion has occurred, by determining whether or not the one-way delay time that is included in the response packet exceeds a predetermined threshold value (step S39). When the one-way delay time is equal to or less than the threshold value, or in other words, when the congestion has not occurred, the rate changing unit 214 instructs, for each tenant, the reading unit 2223 or 2225 to raise the reading rate for the physical server that is the transmission source of the response packet (step S43). For example, the rate changing unit 214 sets the minimum rate of (the reading rate stored in the data storage unit 215+the minimum guaranteed rate) and the line rate between the physical server X and the switch SW3. In other words, the rate changing unit 214 increases the current reading rate by the minimum guaranteed rate until the reading rate reaches the line rate. Processing then returns to step S21.

On the other hand, when the one-way delay time exceeds the predetermined threshold value, it is determined that the congestion has occurred. Therefore, the rate changing unit 214 instructs, for each tenant, the reading unit 2223 or 2225 to lower the reading rate for the physical server that is the transmission source of the response packet so that the rate does not become less than the minimum rate that was calculated at the step S37 (step S41). For example, the rate changing unit 214 sets the maximum value of a value obtained by dividing the reading rate stored in the data storage unit 215 by “2” and the minimum rate. In other words, the rate changing unit 214 divides the current reading rate in half until the reading rate reaches the minimum rate.

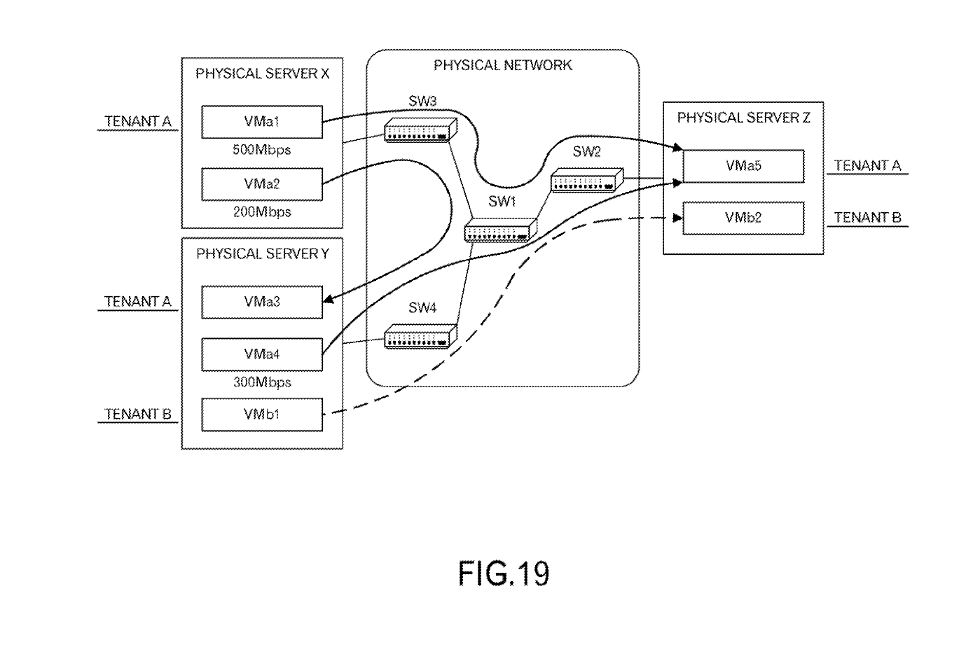

For example, communication as illustrated in FIG. 10 is carried out, however, as illustrated in FIG. 19, the case in which the virtual machine VMb1 of the tenant B does not carry out data transmission is considered. Then, it is assumed that the virtual machine VMa1 of the tenant A is transmitting data to the virtual machine VMa5 on the physical server Z at 500 Mbps, and the virtual machine VMa4 of the tenant A is transmitting data to the virtual machine VMa5 on the physical server Z at 300 Mbps. It is also assumed that data is being transmitted from the virtual machine VMa2 of the tenant A to the virtual machine VMa3 on the physical server Y at 200 Mbps.

In this case, the rate in the link between the switch SW1 and the switch SW2 is 800 Mbps, so does not reach the link rate of 1 Gbps. Therefore, it is determined that the congestion has not occurred. Moreover, it is assumed that the minimum guaranteed rate for the tenant A is 200 Mbps, and the minimum guaranteed rate for the tenant B is 400 Mbps.

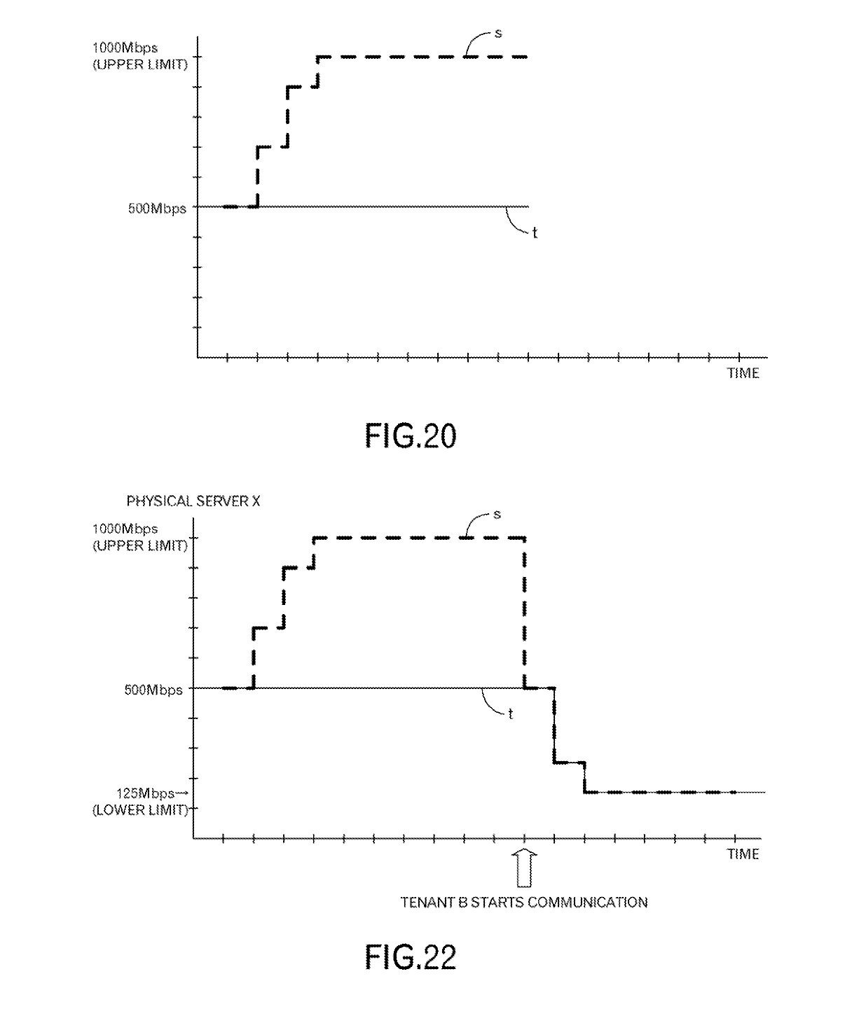

As a result, the rate changing unit 214 of the physical server X sets the reading rate such as illustrated in FIG. 20 to the reading unit 2225 that reads packets from the queue for the physical server Z in the communication unit 222 in the logical configuration unit 220 of the tenant A. In FIG. 20, the horizontal axis represents time, the vertical axis represents the reading rate, and the time change of the reading rate is expressed by the dashed line s. When it is assumed that the initial reading rate is 500 Mbps, the rate changing unit 214 sets 700 Mbps by increasing the reading rate by the minimum guaranteed rate of the tenant A of 200 Mbps. Furthermore, when it is determined that there is no congestion, the rate change unit 214 sets 900 Mbps by further increasing the reading rate by 200 Mbps. Furthermore, when it is determined that there is no congestion, the rate changing unit 214 further increases the reading rate to 1 Gbps. However, when the virtual machine VMa1 does not output data at a rate more than 500 Mbps, the actual rate at which data is read does not change as illustrated by the solid line t.

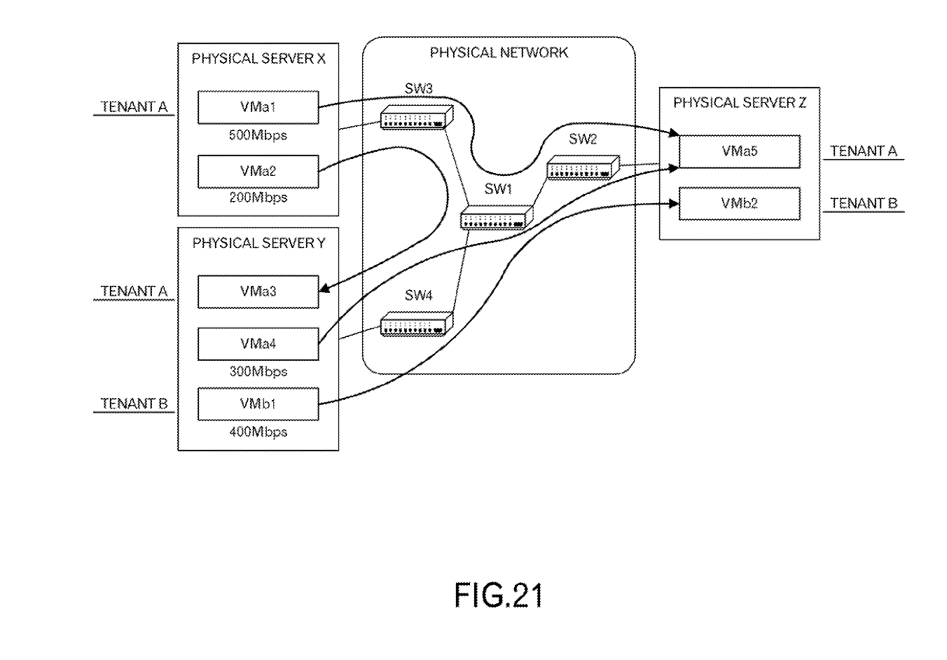

After that, as illustrated in FIG. 21, it is assumed that the virtual machine VMb1 of the tenant B begins to transmit data to the virtual machine VMb2 that is executed on the physical server Z at 400 Mbps. As a result, there is an attempt to transmit data in the link between the switch SW1 and the switch SW2 at a total 1200 Mbps. This causes the congestion, so the processing as described above is carried out for the tenant A, and a ratio 500/(500+300)=0.625 is calculated for the physical server X, and a ratio 300/(500+300)=0.375 is calculated for the physical server Y. As a result, a minimum rate of 200 Mbps*0.625=125 Mbps is calculated for the physical server X, and a minimum rate of 200 Mbps*0.375=75 Mbps is calculated for the physical server Y.

As illustrated in FIG. 22, in the physical server X, 1 Gbps/2=500 Mbps is set as the reading rate s. In the case that this cannot eliminate the congestion, the reading rate s is further changed to 500 Mbps/2=250 Mbps. Here, the actual reading rate t is also lowered to 250 Mbps, so many packets are accumulated at the queue 2224 for the physical server Z. When the congestion is still not eliminated, 250 Mbps/2=125 Mbps is set as the reading rate s, however, this is the minimum rate, so the reading rate is not lowered more than this level.

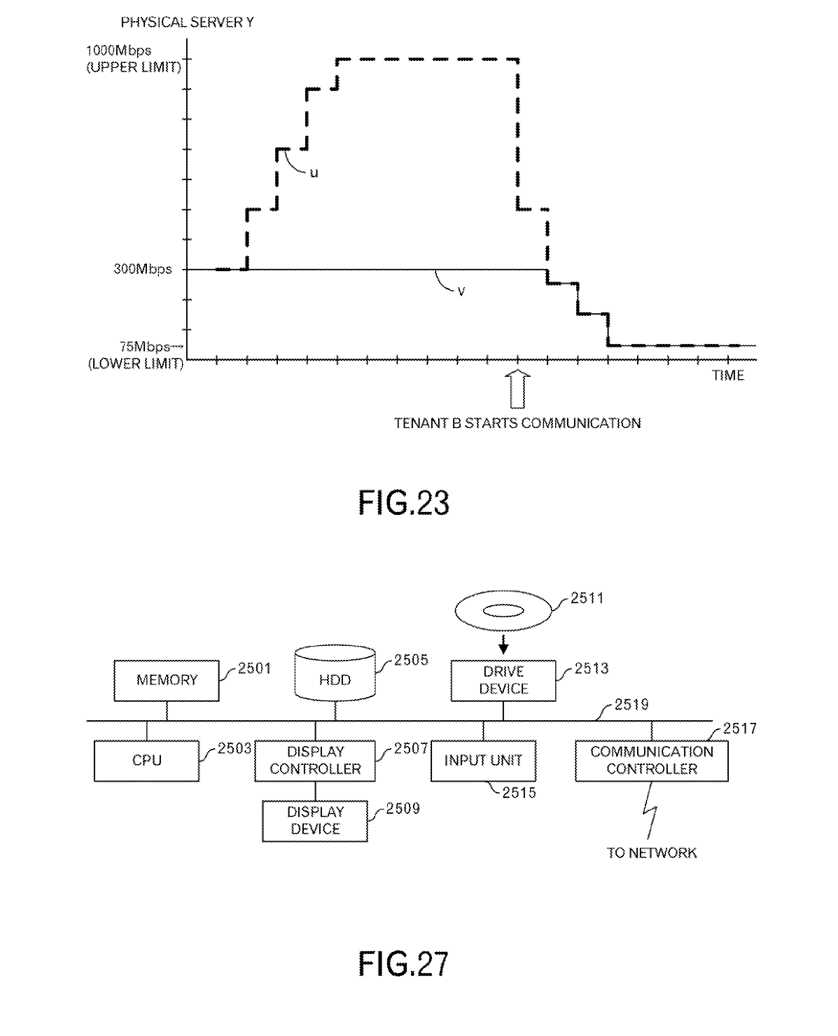

Similarly, as illustrated in FIG. 23, in the physical server Y, while it is determined that the congestion does not occur, the reading rate u that is set by the rate changing unit 214 increases from 300 Mbps to 1 Gbps. However, the transmission rate for data that is output by the virtual machine VMa4 is still 300 Mbps. Therefore, as illustrated by the solid line v, the actual reading rate is fixed at 300 Mbps. However, when the occurrence of the congestion is detected, 1 Gbps/2=500 Mbps is set as the reading rate u. In the case that the congestion is not eliminated by this, the reading rate u is further changed to 500 Mbps/2=250 Mbps. Here, the actual reading rate v is also lowered to 250 Mbps. Therefore, many packets are accumulated at the queue for the physical server Z. In the case that the congestion is still not eliminated, 250 Mbps/2=125 Mbps is set as the reading rate u. Furthermore, in the case that the congestion is still not eliminated, the reading rate u is changed to the lower limit rate of 75 Mbps.

Even in the worst case, placing attention on the tenant A, the physical server X is able to transmit data at 125 Mbps, and the physical server Y is able to transmit data at 75 Mbps, so the total is 200 Mbps, and it is possible to secure the minimum guaranteed rate for the tenant A. In other words, it is possible to secure the minimum guaranteed rate even in the worst case.

On the other hand, in the link between the switch SW1 and the switch SW2, the rate becomes 600 Mbps (=the rate of 200 Mbps for the tenant A+the rate of 400 Mbps for the tenant B), and the congestion is eliminated. When the capacity of each link is adequately designed, the congestion is resolved by carrying out the processing described above.

In order to more easily understand the explanation above, the transmitting side and receiving side were divided, however, actually each physical machine has both configurations.

### Embodiment 3

In the second embodiment, an example was described in which data about the transmission time was included in the request packet, which is a control packet, however, there are cases that there is variation among the clocks of the physical servers. Therefore, a processing such as in this embodiment may be carried out.

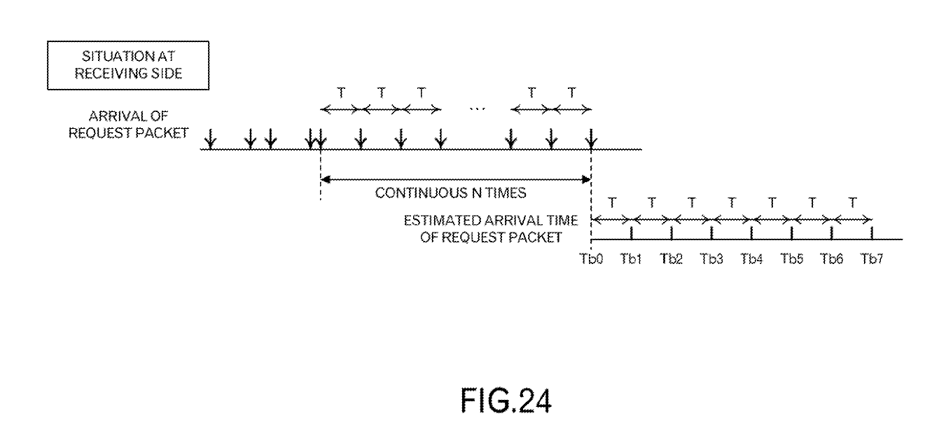

More specifically, as illustrated in FIG. 24, the receiving interval of the request packet is measured by the physical server on the receiving side, and when request packets could be received continuously N times at a transmission interval T of the request packets, it is assumed that the congestion has not occurred. It is presumed according to this state, that a normal communication state is obtained, and with the receiving time Tb0 of the N-th packet as a reference, the estimated arrival times Tb1 to Tb7 (here, “7” is used, but the number is typically an integer m) are generated at a transmission interval T. Based on the estimated arrival times, the one-way delay time is estimated from the difference with the actual receiving times.

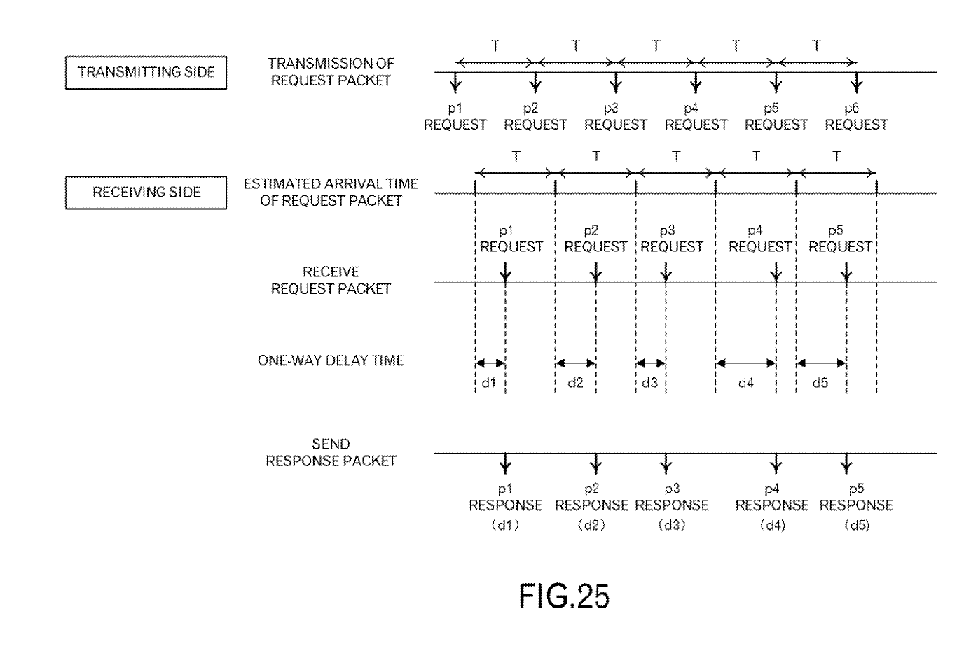

More specifically, as illustrated in FIG. 25, the physical server on the transmitting side transmits request packets p1 to p6 at a transmission interval T, however, even when there is no congestion in the network there is a network delay. Therefore, the estimated arrival time for the request packets lags the transmission time on the receiving side. Furthermore, actually, depending on the state of the network, delay may occur. Therefore, the actual receiving times of the request packets p1 to p6 may lag the estimated arrival times. This time lag is used as the one-way delay times d1 to d5. Due to the spatial relationship of the figure, the receiving time for packet p6 is not illustrated. Moreover, the response packets are transmitted soon after the actual receiving time.

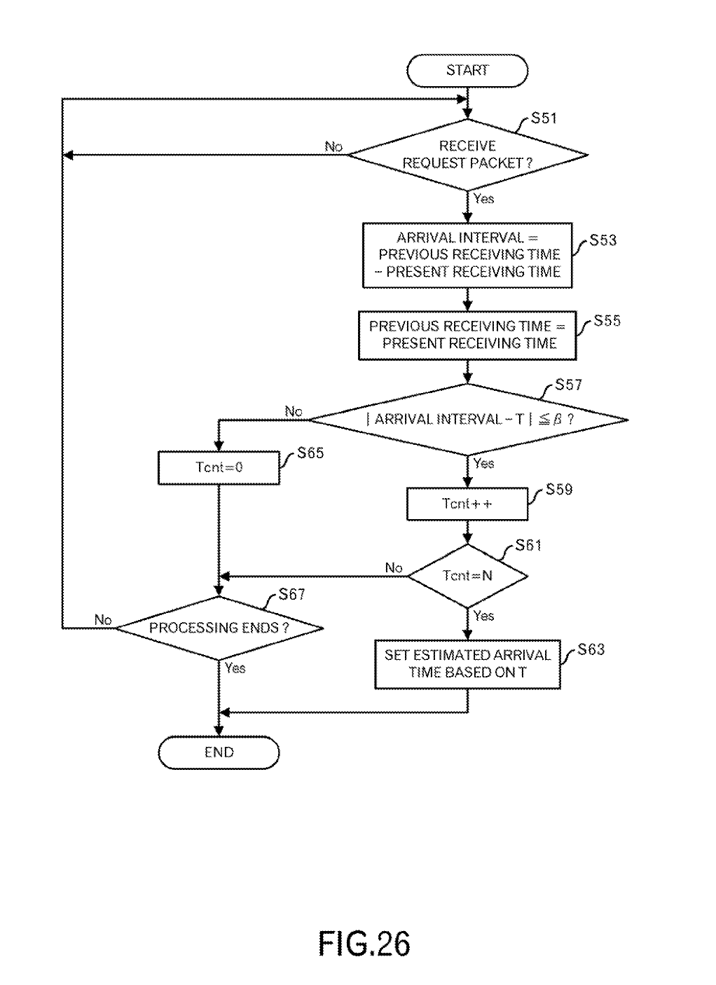

The congestion detector 333 in FIG. 16 carries out a processing such as illustrated in FIG. 26 in order to calculate the one-way delay time as described above.

When a request packet is received (step S51: YES route), the congestion detector 333 calculates the arrival interval from (the time when the previous packet was received—the time when the current packet was received) (step S53). In the case of a packet other than the request packet (step S51: NO route), the processing waits until a request packet is received. The congestion detector 333 sets the current receiving time as the previous receiving time (step S55).

As a result, the congestion detector 333 determines whether |arrival interval−transmission interval T| is equal to or less than an allowable amount of time β (step S57). The allowable amount of time β is time that represents the allowable variation in the arrival interval. When |arrival interval−transmission interval T| is not equal to or less than the allowable time 13, the processing starts over from the beginning. Therefore, the congestion detector 333 initializes the counter Tcnt to 0 (step S65). When the processing is not finished (step S67: NO route), the processing returns to the step S51. However, when the processing is finished (step S67: YES route), the processing ends.

On the other hand, when |arrival interval−transmission interval T| is equal to or less than the allowable time 13, the congestion detector 333 increments the counter Tcnt by “1” (step S59), and determines whether the counter Tcnt has reached the threshold value N (step S61). When the counter Tcnt has not reached the threshold value N, the processing advances to step S67. However, when the counter Tcnt has reached the threshold value N, the congestion detector 333 sets the estimated arrival time with the transmission interval T based on the current receiving time (step S63). After that, the congestion detector 333 calculates the one-way delay time from the difference between the estimated arrival time and the actual receiving time.

By carrying out the processing described above, even when there is variation in the time clock among physical servers, it is possible to accurately estimate the one-way delay time.

Although the embodiments of this technique were explained above, this technique is not limited to those embodiments. For example, the aforementioned functional blocks are mere examples, and may not always correspond to actual program module configurations. Furthermore, as for the processing flow, as long as the processing results do not change, the order of the steps may be exchanged, or the steps may be executed in parallel.

In addition, the aforementioned physical machine and physical server are computer devices as illustrated in FIG. 27. That is, a memory 2501 (storage device), a CPU 2503 (processor), a hard disk drive (HDD) 2505, a display controller 2507 connected to a display device 2509, a drive device 2513 for a removable disk 2511, an input device 2515, and a communication controller 2517 for connection with a network are connected through a bus 2519 as illustrated in FIG. 27. An operating system (OS) and an application program for carrying out the foregoing processing in the embodiment, are stored in the HDD 2505, and when executed by the CPU 2503, they are read out from the HDD 2505 to the memory 2501. As the need arises, the CPU 2503 controls the display controller 2507, the communication controller 2517, and the drive device 2513, and causes them to perform necessary operations. Besides, intermediate processing data is stored in the memory 2501, and if necessary, it is stored in the HDD 2505. In this embodiment of this technique, the application program to realize the aforementioned functions is stored in the computer-readable, non-transitory removable disk 2511 and distributed, and then it is installed into the HDD 2505 from the drive device 2513. It may be installed into the HDD 2505 via the network such as the Internet and the communication controller 2517. In the computer as stated above, the hardware such as the CPU 2503 and the memory 2501, the OS and the necessary application programs systematically cooperate with each other, so that various functions as described above in details are realized.

The aforementioned embodiments are summarized as follows:

A control method relating to the embodiments includes: (A) measuring a transmission rate of data to be transmitted to a second physical computer, for a group to which one or plural virtual machines executed on a first physical computer (also called physical machine or physical server) belong; (B) transmitting a request packet including the measured transmission rate to the second physical computer; (C) receiving, from the second physical computer, a response packet including a ratio for the group and first data used in determining whether congestion has occurred; and (D) upon determining based on the first data, that the congestion has occurred, lowering an output rate of data that the one or plural virtual machines belonging to the group output to the second physical server so as to be equal to or greater than a lower limit value determined by a product of the ratio for the group and a transmission rate that is preset for the group.

When the output rate that is preset for the group is a minimum guaranteed rate, it is possible to control the transmission rate so as not to be less than the minimum guaranteed rate in the entire system, even when plural physical computers that execute virtual machines belonging to the same group transmit data to the second physical computer.

Moreover, the control method relating to the embodiments may further include: (E) receiving, from a third physical machine, a second request packet including a second transmission rate that was measured for a second group to which a virtual machine executed on the third physical machine belong; (F) first generating, from the second request packet, second data used in determining whether congestion has occurred between the first physical computer and the third physical computer, for the second group; (G) calculating a ratio for the second group, wherein the ratio is determined by a rate of the second transmission rate with respect to a sum of a total sum of third transmission rates for the second group, which are included in a request packet from another physical computer, and the second transmission rate; (H) second generating a response packet including the ratio for the second group and the second data; and (I) transmitting the response packet to the third physical computer.

By doing so, it becomes possible for the third physical computer to control the transmission rate so as to secure the minimum guaranteed rate for the second group even in case of the congestion.

The ratio may be a ratio of the transmission rate included in the request packet with respect to a sum of a total sum of transmission rates for the group, which are included in request packets received from other physical computers, and the transmission rate included in the request packet.

Moreover, the first data may be a one-way delay time, and upon detecting that the one-way delay time exceeds a threshold value, it may be determined that the congestion has occurred. Incidentally, the occurrence of the congestion may be detected by other methods. For example, data used in determining whether or not the congestion has occurred may be a flag representing whether or not the congestion has occurred.

Furthermore, the control method relating to the embodiments may further include: upon determining based on the first data, that no congestion occurs, heightening the output rate of the data that the one or plural virtual machines belonging to the group outputs to the second physical server. The output rate may be maintained instead of raising.

The aforementioned first generating may include: after confirming that no congestion occurs from the third physical computer to the first physical computer, setting time determined by adding time when the second request packet was received and an transmission interval of the second request packet, as estimated arrival time of a next second request packet; and calculating a difference between the estimated arrival time and actual time when the next second request packet was received. By doing so, it is possible to calculate the one-way delay time, accurately.

A control method relating to a second aspect of the embodiments includes: (A) receiving, from a second physical computer, a request packet including a transmission rate measured for a group to which a virtual machine executed on the second physical computer belongs; (B) generating, for the group, data used in determining whether or not congestion has occurred between the first physical computer and the second physical computer, from the request packet; (C) calculating a ratio for the group, by calculating a rate of the transmission rate with respect to a sum of a total sum of second transmission rates for the group, which are included in request packets received from other physical computers, and the transmission rate; (D) generating a response packet including the ratio for the group and the generated data; and (E) transmitting the response packet to the second physical computer.

Incidentally, it is possible to create a program causing a computer to execute the aforementioned processing, and such a program is stored in a computer readable storage medium or storage device such as a flexible disk, CD-ROM, DVD-ROM, magneto-optic disk, a semiconductor memory, and hard disk. In addition, the intermediate processing result is temporarily stored in a storage device such as a main memory or the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A computer-readable, non-transitory storage medium storing a program for causing a first physical computer to execute a procedure, the procedure comprising:
measuring a transmission rate of data to be transmitted to a second physical computer, for a group to which one or plural virtual machines executed on the first physical computer belong;
transmitting a request packet including the measured transmission rate to the second physical computer;
receiving, from the second physical computer, a response packet including a ratio for the group and first data used in determining whether congestion has occurred; and
upon determining based on the first data, that the congestion has occurred, lowering an output rate of data that the one or plural virtual machines belonging to the group output to the second physical server to a second output rate that is equal to or greater than a lower limit value determined by a product of the ratio for the group and a transmission rate that is preset for the group, wherein the second output rate is less than a present output rate.

2. The computer-readable, non-transitory storage medium as set forth in claim 1, wherein the procedure further comprises:
receiving, from a third physical machine, a second request packet including a second transmission rate that was measured for a second group to which a virtual machine executed on the third physical machine belong;
first generating, from the second request packet, second data used in determining whether congestion has occurred between the first physical computer and the third physical computer, for the second group;
calculating a ratio for the second group, wherein the ratio is determined by a rate of the second transmission rate with respect to a sum of a total sum of third transmission rates for the second group, which are included in a request packet from another physical computer, and the second transmission rate;
second generating a response packet including the ratio for the second group and the second data; and
transmitting the response packet to the third physical computer.

3. The computer-readable, non-transitory storage medium as set forth in claim 1, wherein the ratio is a ratio of the transmission rate included in the request packet with respect to a sum of a total sum of transmission rates for the group, which are included in request packets received from other physical computers, and the transmission rate included in the request packet.

4. The computer-readable, non-transitory storage medium as set forth in claim 1, wherein the first data is a one-way delay time, and upon detecting that the one-way delay time exceeds a threshold value, it is determined that the congestion has occurred.

5. The computer-readable, non-transitory storage medium as set forth in claim 1, wherein the procedure further comprises:
upon determining based on the first data, that no congestion occurs, heightening the output rate of the data that the one or plural virtual machines belonging to the group outputs to the second physical server.

6. The computer-readable, non-transitory storage medium as set forth in claim 2, wherein the first generating comprises:
after confirming that no congestion occurs from the third physical computer to the first physical computer, setting time determined by adding time when the second request packet was received and an transmission interval of the second request packet, as estimated arrival time of a next second request packet; and
calculating a difference between the estimated arrival time and actual time when the next second request packet was received.

7. A computer-readable, non-transitory storage medium storing a program for causing a first physical computer to execute a procedure, the procedure comprising:
receiving, from a second physical computer, a request packet including a transmission rate measured for a group to which a virtual machine executed on the second physical computer belongs;
generating, for the group, data used in determining whether or not congestion has occurred between the first physical computer and the second physical computer, from the request packet;
calculating a ratio for the group, by calculating a rate of the transmission rate with respect to a sum of a total sum of second transmission rates for the group, which are included in request packets received from other physical computers, and the transmission rate;
generating a response packet including the ratio for the group and the generated data; and
transmitting the response packet to the second physical computer.

8. A control method, comprising:
measuring, by using a first physical computer, a transmission rate of data to be transmitted to a second physical computer, for a group to which one or plural virtual machines executed on the first physical computer belong;
transmitting, by using the first physical computer, a request packet including the measured transmission rate to the second physical computer;
receiving, by the first physical computer, from the second physical computer, a response packet including a ratio for the group and first data used in determining whether congestion has occurred; and
upon determining based on the first data, that the congestion has occurred, lowering, by using the first physical computer, an output rate of data that the one or plural virtual machines belonging to the group output to the second physical server to a second output rate that is equal to or greater than a lower limit value determined by a product of the ratio for the group and a transmission rate that is preset for the group, wherein the second output rate is less than a present output rate.

9. A control method, comprising:
receiving, by using a first physical computer, from a second physical computer, a request packet including a transmission rate measured for a group to which a virtual machine executed on the second physical computer belongs;
generating, by using the first physical computer, for the group, data used in determining whether or not congestion has occurred between the first physical computer and the second physical computer, from the request packet;
calculating, by using the first physical computer, a ratio for the group, by calculating a rate of the transmission rate with respect to a sum of a total sum of second transmission rates for the group, which are included in request packets received from other physical computers, and the transmission rate;
generating, by using the first physical computer, a response packet including the ratio for the group and the generated data; and
transmitting, by using the first physical computer, the response packet to the second physical computer.

10. An information processing apparatus, comprising:
a memory;
a processor configured to use the memory to execute a procedure, the procedure comprising:
measuring a transmission rate of data to be transmitted to a second physical computer, for a group to which one or plural virtual machines executed on the information processing apparatus belong;
transmitting a request packet including the measured transmission rate to the second physical computer;
receiving, from the second physical computer, a response packet including a ratio for the group and first data used in determining whether congestion has occurred; and
upon determining based on the first data, that the congestion has occurred, lowering an output rate of data that the one or plural virtual machines belonging to the group output to the second physical server to a second output rate that is equal to or greater than a lower limit value determined by a product of the ratio for the group and a transmission rate that is preset for the group, wherein the second output rate is less than a present output rate.

11. An information processing apparatus, comprising:
a memory;
a processor configured to use the memory to execute a procedure, the procedure comprising:
receiving, from a second physical computer, a request packet including a transmission rate measured for a group to which a virtual machine executed on the second physical computer belongs;
generating, for the group, data used in determining whether or not congestion has occurred between the information processing apparatus and the second physical computer, from the request packet;
calculating a ratio for the group, by calculating a rate of the transmission rate with respect to a sum of a total sum of second transmission rates for the group, which are included in request packets received from other physical computers, and the transmission rate;
generating a response packet including the ratio for the group and the generated data; and
transmitting the response packet to the second physical computer.
